(19) United States
(12) Patent Application Publication
(10) Pub. No.: US 2026/0091984 A1
(43) Pub. Date: Apr. 2, 2026

(54) MULTI-ELEMENT DOPED CATHODE MATERIAL

(71) Applicant: GM Global Technology Operations LLC, Detroit, MI (US)

(72) Inventors: Dewen Kong, Shanghai (CN); Haijing Liu, Shanghai (CN); Jingyuan Liu, Shanghai (CN); Yan Wu, Shanghai (CN)

(21) Appl. No.: 18/922,752

(22) Filed: Oct. 22, 2024

(30) Foreign Application Priority Data
Sep. 29, 2024 (CN) 202411379574.4

(51) Int. Cl. C01G 49/00; H01M 4/02; H01M 4/136; H01M 4/36

(52) U.S. Cl. CPC C01G 49/009; H01M 4/136; H01M 4/366; C01P 2002/52; C01P 2004/61; C01P 2004/62; C01P 2004/64; C01P 2006/11; C01P 2006/12; C01P 2006/40; H01M 2004/028; H01M 2220/20

(57) ABSTRACT

A lithium manganese iron phosphate (LMFP) based vehicle battery cell, a battery for an electric vehicle, and a method is provided. The battery cell includes a cathode current collector and a cathode having a multiple element-doped active material. The active material includes LMFP formed using multiple element doping and having the formula LiMnₐFe_{b}Mg_{c}Ti_{d}CoₑNb_{f}Y_{g}PO₄, where the value a is equal to or greater than 0.5, the value b is equal to or greater than 0.1, the value c is equal to or greater than 0.0005 and equal to or less than 0.1, the value d is equal to or greater than 0.0005 and equal to or less than 0.1, the value e is equal to or less than 0.05, the value f is equal to or less than 0.02, and the value g is equal to or less than 0.05.

### INTRODUCTION

The present disclosure relates to a battery pack, and more particularly, to a doped cathode disposed within the battery pack.

Electric and hybrid electric vehicle technology is enabled by the development and deployment of rechargeable, secondary batteries, which provide energy to the vehicle powertrain. Secondary batteries include lithium ion batteries, which generally include a cathode, anode, separator, and electrolyte. The cathode provides a source of lithium ions and determines capacity and average voltage of a battery. The anode stores and releases lithium ions received from the cathode when energy is needed. The separator prevents the cathode and anode from contacting and shorting out the battery, and the electrolyte provides a medium between the cathode and anode through which the lithium ions travel. Energy density, or areal capacity, of the secondary battery may be increased by adding more cathode and anode active material and increasing the density of the cathode and anode.

Cathode electrodes and anode electrodes are formed by coating current collectors with active cathode material and active anode material, respectively. The coatings often include the active materials, a binder, additives, and/or a solvent. At least in the case of cathodes, the active materials disposed on the current collectors are responsible for the electrochemical reactions that store and release energy during battery operation.

One of the primary issues is the mechanical and chemical stability of the cathode active materials during repeated charge and discharge cycles. Degradation of the cathode can lead to reduced capacity, lower efficiency, and shorter battery life. Another challenge is the need for higher energy density and faster charging capabilities. The current collector must be optimized to ensure efficient electron transport and minimize energy losses.

Thus, while present lithium cathode chemistries achieve their intended purpose, there is a need for new and improved cathode chemistries that offer improved electronic and ionic conductivities and better cyclability.

### SUMMARY

According to several aspects of the present disclosure, a lithium manganese iron phosphate (LMFP) based vehicle battery cell is provided. The vehicle lithium manganese iron phosphate (LMFP) based vehicle battery cell includes a cathode current collector and a cathode including a multiple element-doped active material disposed on a surface of the cathode current collector. The active material includes lithium manganese iron phosphate (LMFP) formed using multiple element doping having the formula LiMnₐFe_{b}Mg_{c}Ti_{d}CoₑNb_{f}Y_{g}PO₄. In the formula LiMnₐFe_{b}Mg_{c}Ti_{d}CoₑNb_{f}Y_{g}PO₄, the value a is equal to or greater than 0.5, the value b is equal to or greater than 0.1, the value c is equal to or greater than 0.0005 and equal to or less than 0.1, the value d is equal to or greater than 0.0005 and equal to or less than 0.1, the value e is equal to or less than 0.05, the value f is equal to or less than 0.02, and the value g is equal to or less than 0.05.

In accordance with another aspect of the disclosure, the value a is between 0.5 and 0.8.

In accordance with another aspect of the disclosure, the value b is equal to or greater than 0.2 and equal to or less than 0.5.

In accordance with another aspect of the disclosure, the value c is between 0.01 and 0.05.

In accordance with another aspect of the disclosure, the value d is between 0.005 and 0.03.

In accordance with another aspect of the disclosure, the value e is between 0.005 and 0.03.

In accordance with another aspect of the disclosure, the value f is between 0.0001 and 0.01.

In accordance with another aspect of the disclosure, the value g is between 0.0005 and 0.02.

In accordance with another aspect of the disclosure, the cathode includes a carbon coating that is between 0.5-10 weight % (wt. %).

In accordance with another aspect of the disclosure, a primary particle size of the cathode is between 10-1000 nanometers, and a secondary particle size of the cathode is between 0.5-20 micrometers.

In accordance with another aspect of the disclosure, a tap density of the cathode is between 0.3-2.0 grams per cubic centimeter.

In accordance with another aspect of the disclosure, a specific surface area of the cathode is between 3-50 square meters per gram.

According to several aspects of the present disclosure, a battery for an electric vehicle is provided. The battery includes a battery cell including a cathode including a multiple element doped active material disposed on a surface of a cathode current collector, an anode disposed on an anode current collector, a separator positioned between the cathode and the anode, and an electrolyte configured for carrying ions between the cathode and the anode. The active material includes lithium manganese iron phosphate (LMFP) formed using multiple element doping having the formula LiMnₐFe_{b}Mg_{c}Ti_{d}CoₑNb_{f}Y_{g}PO₄. In the formula LiMnₐFe_{b}Mg_{c}Ti_{d}CoₑNb_{f}Y_{g}PO₄, the value a is equal to or greater than 0.5, the value b is equal to or greater than 0.1, the value c is equal to or greater than 0.0005 and equal to or less than 0.1, the value d is equal to or greater than 0.0005 and equal to or less than 0.1, the value e is equal to or less than 0.05, the value f is equal to or less than 0.02, and the value g is equal to or less than 0.05.

In accordance with another aspect of the disclosure, the cathode includes a carbon coating that is between 0.5-10 weight % (wt. %).

In accordance with another aspect of the disclosure, a primary particle size of the cathode is between 10-1000 nanometers, and a secondary particle size of the cathode is between 0.5-20 micrometers.

In accordance with another aspect of the disclosure, a tap density of the cathode is between 0.3-2.0 grams per cubic centimeter.

In accordance with another aspect of the disclosure, a specific surface area of the cathode is between 3-50 square meters per gram.

According to several aspects of the present disclosure, a method for forming a cathode for a battery cell in an electric vehicle battery pack is provided. The method includes forming a precursor, adding at least one dopant element to the precursor, milling the precursor and the at least one dopant element, adding a carbon precursor to the slurry, and calcinating the slurry to form an active cathode material. The precursor includes manganese(II) sulfate (MnSO₄), iron(II) sulfate (FeSO₄), and phosphoric acid (H₃PO₄). The at least one dopant element includes at least one of a hydrated mixed metal phosphate compound (HMnFePO₄·H₂O), lithium carbonate (Li₂CO₃), titanium oxide, magnesium oxide, cobalt oxide, yttrium oxide, or niobium oxide, wherein a slurry is formed.

In accordance with another aspect of the disclosure, the carbon precursor is glucose.

In accordance with another aspect of the disclosure, calcinating the slurry includes calcinating at a temperature between about 600-800° C.

The above features and advantages, and other features and advantages, of the presently disclosed system and method are readily apparent from the detailed description, including the claims, and examples when taken in connection with the accompanying drawings.

### BRIEF DESCRIPTION OF THE DRAWINGS

The present disclosure will become more fully understood from the detailed description and the accompanying drawings, wherein:

FIG. 1 is a perspective view illustrating an example of a vehicle having an electric motor powered by a battery pack having a lithium manganese iron phosphate-based cathode, in accordance with the present disclosure.

FIG. 2 is a cross section schematic view of a battery cell in the battery pack in the vehicle shown in FIG. 1, where the battery cell includes a lithium manganese iron phosphate-based cathode, in accordance with the present disclosure.

FIG. 3 is a flowchart illustrating a method for forming the cathode electrode for the battery cell in an electric vehicle battery pack as shown in FIG. 2, in accordance with the present disclosure.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale. The following description is merely exemplary in nature and is not intended to limit the present disclosure, application, or uses.

A lithium manganese iron phosphate (LMFP) cathode active material is disclosed herein. The LMFP cathode active material is enabled by multi-element doping. LMFP cathode active materials were doped using single element doping, and a preferred doping amount for each element was determined using half coin cells. At a 1 C charging rate, all doped LMFP cathode active materials exhibit an improved charge capability including a lower charge voltage and a higher constant current (CC) capacity ratio. For example, magnesium (Mg), cobalt (Co), niobium (Nb), titanium (Ti), and yttrium (Y) doped cathode active material demonstrate higher discharge voltage and improved cycle life. The optimized LMFP cathode active materials disclosed herein deliver a higher constant current charge ratio during a charging process. Compared to conventional LMFP cathode materials, the optimized LMFP cathode active materials exhibit improved discharge rate performance, higher discharge voltage, and enhanced 1 C/1 C cycling stability.

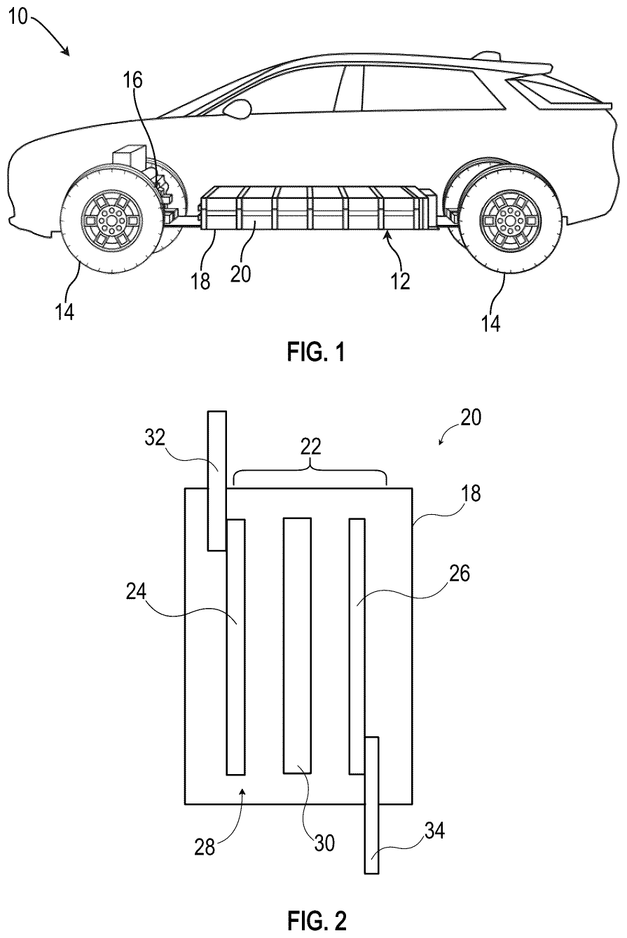

Referring to FIG. 1, a perspective view of a vehicle 10 having a battery pack 12 is illustrated, in accordance with the present disclosure. The battery pack 12 is illustrated with an exemplary vehicle 10. The vehicle 10 is an electric vehicle or hybrid vehicle having wheels 14 driven by at least one electric motor/inverter 16. The electric motors/inverters 16 receive power from the battery pack 12. While the vehicle 10 is illustrated as a passenger road vehicle, it should be appreciated that the battery pack 12 may be used with various other types of vehicles. For example, the battery pack 12 may be used in nautical vehicles, such as boats, or aeronautical vehicles, such as drones or passenger airplanes. Moreover, the battery pack 12 may be used as a stationary power source separate and independent from a vehicle. Battery pack 12 includes a housing 18 for carrying and supporting a plurality of battery cells 20. In an example, the battery pack 12 may have fifty or more battery cells 20.

As used herein, the term “vehicle” is not limited to automobiles. While the present technology is described primarily herein in connection with electric and hybrid-electric vehicles, the technology is not limited to electric and hybrid-electric vehicles. The concepts can be used in a wide variety of applications, such as in connection with components used in motorcycles, mopeds, locomotives, aircraft, marine craft, and other vehicles, as well as in other applications utilizing batteries, such as in portable power stations, such as those used for powering remote job sites, emergency back-up power supplies, and permanent power stations associated with buildings and equipment, all of which may be powered by, for example, solar or wind-powered generator systems, power mains, and fuel based power generators such as gasoline, propane, kerosene, or diesel generators as well as sterling engines.

FIG. 2 illustrates one battery cell 20 within the battery pack 12 illustrated in FIG. 1. The battery pack 12 and the battery cells 20 are understood to be rechargeable batteries that may be discharged upon application of a load and recharged upon the application of an external power source. The battery cells 20 may be, for example, pouch-style or prismatic cells. Alternatively, the battery cells 20 may be cylindrical-style cells.

Each battery cell 20 disposed within the battery pack 12 shown in FIG. 1 has a housing 18 or case and at least one electrode stack 22, which further includes a cathode 24, an anode 26, an electrolyte 28, and/or a separator 30. Each battery cell 20 may have tens or hundreds of electrode stacks 22. Each electrode stack 22 is connected to a current collector 32, 34. The electrode stacks are placed in the housing 18, which are filled with an electrolyte 28. The electrolyte 28 transports ions between the cathode 24 and the anode 26. The current collectors 32, 34 are thin metal plates or foils disposed on sides of the electrode stacks 22 and/or housing 18 and typically have a thickness between 0.1 and 1 millimeter. The current collectors 32, 34 may be made of copper or aluminum and are attached to the electrode stacks 22 to transmit the electric current to an external circuit (not shown).

During discharge, when a load is applied to the battery cells 20, Li+ions move from the anode 26 to the cathode 24 through the separator 30 by way of the electrolyte 28. Equivalent electrons e-move through battery circuitry from the cathode 24 to the anode 26, providing energy to a battery load. While charging and upon application of an external voltage, Li⁺ions move from the cathode 24 to the anode 26 by way of the electrolyte 28 through the separator 30 and may be intercalated into the anode 26.

Each battery cell 20, such as that illustrated in FIG. 2, generally includes a cathode current collector 32, a cathode 24 disposed on the cathode current collector 32, an anode current collector 34, an anode 26 disposed on the anode current collector 34, a separator 30 positioned between the cathode 24 and anode 26, and an electrolyte 28. While the illustrated battery cells 20 include one anode 26 (and anode current collector 34) and one cathode (and one cathode current collector 32), the battery cell 20 may alternatively include two or more cathodes 24 (and cathode current collectors 32) and one or more anodes 26 (and anode current collectors 34). In further alternative embodiments, the battery cell 20 may include or one or more cathodes 24 (and cathode current collectors 32) and two or more anodes 26 (and anode current collectors 34). In any of the designs above, one or more separators 30 are interleaved between the cathodes 24 and anodes 26 to prevent the cathodes 24 and the anodes 26 from contacting.

In the various styles of battery cells 20 noted above, the cathode current collector 32 and anode current collector 34 are formed from conductive materials. In embodiments, the cathode current collector 32 includes aluminum. Alternatively, or additionally, the cathode current collector 32 may include copper clad aluminum and/or stainless steel. The anode current collector 34 may include one or more of copper, nickel, stainless steel, and titanium. The current collectors 32, 34 are illustrated as being in the form of a foil; however, it should be appreciated that other forms may be exhibited such as mesh or a composite-type material. In embodiments, a foil cathode current collector 32 and a foil anode current collector 34 are impermeable to gas. The cathode current collector 32 may exhibit a thickness in the range of 5 micrometers to 50 micrometers including all values and ranges therein, such as in the range of 5 micrometers to 25 micrometers. The anode current collector 34 exhibits a thickness in the range of 4 micrometers to 50 micrometers including all values and ranges therein, such as in the range of 4 micrometers to 25 micrometers, or a specific example of 13 micrometers.

The cathode 24 includes a cathode active material that provides a source of lithium ions (Li⁺) and can undergo reversible insertion or intercalation of lithium ions determining, for example, the capacity and average voltage of a battery. In some examples, the active material includes at least one of lithium iron phosphate (LFP) and/or lithium manganese iron phosphate (LMFP). In embodiments, the cathode active material is present in the range of 82 percent by weight to 97.5 percent by weight of the total weight of the cathode 24, including all values and ranges therein, such as in the range of 91 percent by weight to 96 percent by weight of the total weight of the cathode 24. The total weight of the cathode is 100 weight percent. In embodiments, the cathode active material is provided as powder.

In the example illustrated in FIG. 2, the cathode active material is lithium manganese iron phosphate (LMFP) and is multi element-doped. The multi element-doped lithium manganese iron phosphate (LMFP) exhibits the formula: LiMnₐFe_{b}Mg_{c}Ti_{d}CoₑNb_{f}Y_{g}PO₄, where a+b+c+d+e+f+g=1. In an example, value a is greater than or equal to 0.5, and a preferred range for value a is between 0.5 and 0.8. In an example, value b is greater than or equal to 0.1, and a preferred range for value b is between 0.2 and 0.5. In an example, value c is greater than or equal to 0.0005 and less than or equal to 0.1, and a preferred range for value c is between 0.01 and 0.05. In an example, value d is greater than or equal to 0.0005 and less than or equal to 0.1, and a preferred range for value d is between 0.005 and 0.03. In an example, value e is greater than or equal to 0 and less than or equal to 0.05, and a preferred range for value e is between 0.005 and 0.03. In an example, value f is greater than or equal to 0 and less than or equal to 0.02, and a preferred range for value f is between 0.0001 and 0.01. In an example, value g is greater than or equal to 0 and less than or equal to 0.05, and a preferred range for value g is between 0.0005 and 0.02. In one specific example, the multi element-doped lithium manganese iron phosphate (LMFP) has the following formula: Li(Mn_{0.7}Fe_{0.3})_{0.945}Mg_{0.03}Ti_{0.01}Co_{0.01}Nb_{0.001}Y_{0.004}PO₄, although it will be appreciated that the LMFP may have other formulas that conform with the previously disclosed ranges.

The lithium manganese iron phosphate may exhibit an average primary particle size in the range of 10 nanometers to 1000 nanometers, including all values and ranges therein, such as from 50 nanometers to 300 nanometers. The lithium manganese iron phosphate has an average secondary particle size between about 0.3 micrometers and 20 micrometers. The lithium manganese iron phosphate has a specific surface area in the range of 3 square meters per gram (m²/g) to 50 square meters per gram (m²/g), including all values and ranges therein. In a specific example, the lithium manganese iron phosphate has a specific surface area of 8 square meters per gram to 25 square meters per gram. In addition, the lithium manganese iron phosphate exhibits a tap density in the range of 0.3 grams per cubic centimeter (g/cc) to 2.0 grams per cubic centimeters, including all values and ranges therein, for example 0.6 grams per cubic centimeters to 1.1 grams per cubic centimeters. The moisture content of the lithium manganese iron phosphate is less than 500 parts per million, such as in the range of 350 parts per million to 450 parts per million. In addition, the lithium manganese iron phosphate exhibits a discharge capacity at C/5 (discharge over 5 hours) of 145 milliamp-hours per gram and at C/2 (discharge over 2 hours) of 140 milliamp-hours per gram, as well as a first cycle coulombic efficiency of greater than 96 percent.

A surface area of the cathode current collector 32 may be increased by the addition of a coating or etching. For example, the cathode current collector 32 may include a layer of carbon particles disposed on the surface of the cathode current collector 32 that contacts the cathode 24. The carbon particles may exhibit an average particle size in the range of 20 nanometers to 2000 nanometers, including all values and ranges therein, as observed by scanning electron microscopy. Additionally, the carbon particles or carbon coating may be between 0.5-10 weight % (wt. %) of the cathode 24. The carbon coating may preferably be between 1.0-2.5 wt. %.

The anode 26 includes materials that can undergo reversible insertion or intercalation of lithium ions at a lower electrochemical potential than the cathode 24 material, such that an electrochemical potential difference exists between the anode 26 and cathode 24. The anode 26 may include one or more of lithium metal; alloys of lithium for example lithium silicon alloy, lithium aluminum alloy, lithium indium alloy, lithium titanate, and lithium tin alloy; carbon based materials for example graphite, activated carbon, carbon black and graphene; silicon; silicon based alloys; silicon oxide; silicon based composite materials; tin oxide; aluminum; indium; zinc; germanium; and titanium oxide; as well as any combination of the above. In embodiments, the anode 26 may exhibit a thickness in the range of 50 micrometers to 150 micrometers including all values and ranges therein. The anode 26 may be applied to the anode current collector 34 forming a coating on the anode current collector 34 by using a deposition process, for example a slurry based process, a hot roll pressing process, extrusion, or additive manufacturing. The combined anode 26 and anode current collector 34 provide an anode electrode.

The separator 30 includes a porous material formed of an electrically insulative material that prevents the cathode 24 and the anode 26 from contacting and potentially shortening out the battery circuit. The separator 30 is sandwiched, or at least partially enclosed, between the cathode 24 and anode 26 allowing the passage of the lithium ions and electrolyte 28 through the pores of the separator 30. The separator 30 may include one or more of a composite material, a polymeric material, or a non-woven material. In embodiments, the separator 30 includes at least one of polyethylene, polypropylene, polyamide, polytetrafluoroethylene, polyvinylidene fluoride, and polyvinyl chloride. In addition, the separator 30 may be filled, i.e., include fillers dispersed therein, wherein the filler includes a material such as glass fiber. In additional or alternative embodiments, the separator 30 may include at least one of a thermally stable, porous polymer coating and a ceramic coating such as an alumina coating. The coating is disposed on one or more surfaces of a porous polymer film, the polymer film being selected from at least one of polyethylene and polypropylene. The separator 30 may include one or more layers, wherein each layer is formed from one or more of the materials noted above. The separator 30 may take the form of film or a mesh, such as woven mesh or a slit film. In embodiments, the separator 30 exhibits a thickness in the range of 4 micrometers to 25 micrometers, including all values and ranges therein.

The electrolyte 28 provides a medium between the cathode 24 and anode 26 through which lithium ions and the electrolyte 28 travel. The medium may be a liquid, gel, or solid, and capable of conducting the lithium ions between the cathode 24 and the anode 26. The electrolyte 28 permeates the pores of the porous separator 30 and wets, or otherwise contacts, the surfaces of the cathode 24 and anode 26 as well as the separator 30. In embodiments, the electrolyte 28 includes one or more lithium salts dissolved in non-aqueous organic solvent. The lithium salts may include one or more of the following: lithium hexafluorophosphate (LiPF6), lithium perchlorate (LiClO4), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl) imide (LiN(F_{S}O₂)₂) (LiSFI), lithium (triethylene glycol dimethy 1 ether)bis(trifluoromethanesulfonyl)imide (Li(G₃)(TFSI), or lithium bis(trifluoromethanesulfonyl)azanide (LiTFSA). The lithium salt may be present in the electrolyte 28 at a concentration (moles of salt per liter of solvent) ranging from 1 M to 4 M, including all values and ranges therein, for example 2 M or 3 M.

The non-aqueous aprotic organic solvent includes or more of various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxy ethane), and/or cyclic ethers (e.g., tetrahydrofuran, 2-methyltetrahydrofuran), 1,3-dioxolane).

Further, the electrolyte 28 may include a number of additives, such as, but not limited to vinyl carbonate, vinyl-ethylene carbonate, propane sulfonate, 1,3,2-dioxathiolane 2,2-dioxide (DTD), LiPF₂O₂, and/or combinations thereof. Other additives can include diluents which do not coordinate with lithium ions but can reduce viscosity of the electrolyte 28, such as bis(2,2,2-trifluoroethyl) ether (BTFE), and/or flame retardants, for example triethyl phosphate.

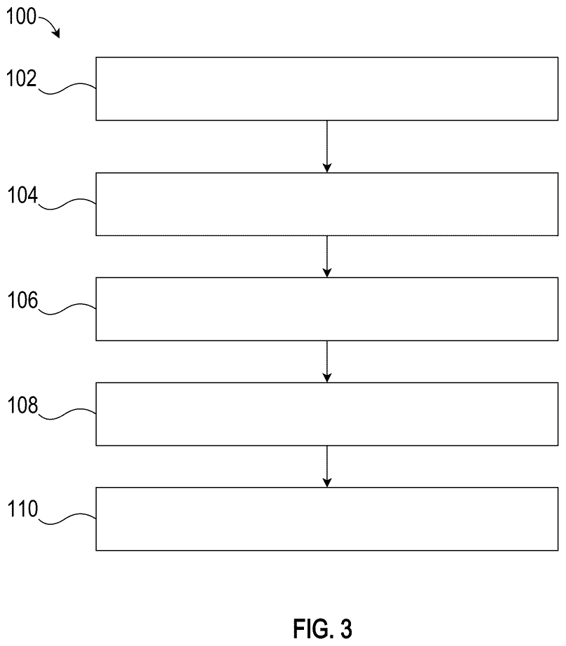

With reference to FIG. 3, a method 100 for forming a cathode electrode 24 for a battery cell 20 in an electric vehicle battery pack 12 is presented, in accordance with the present disclosure. The method starts at block 102.

Block 102 depicts forming a precursor. The precursor includes active materials, where the active materials includes at least manganese(II) sulfate (MnSO4), iron(II) sulfate (FeSO₄), and phosphoric acid (H₃PO₄). Each ingredient of the precursor may be added one at a time or in groups. For example, in one embodiment, dry materials (e.g., fillers, binders, and the like) may be mixed together, then wet materials (e.g., fillers, binders, and the like) may be added to the dry materials and further mixed. The active material may be added to the mixed material, and water may be added to adjust the solids content. It is contemplated that the steps may be rearranged. The precursors may be mixed using a planetary mixer and form a slurry. In addition, or alternatively, other mixers may be used. The mixer can be capable of exhibiting speeds of up to 10,000 rotations per minute, including all values and ranges from 10 rotations per minute to 10,000 rotations per minute.

Block 104 depicts adding at least one dopant element to the precursor. The at least one dopant element includes at least one of a hydrated mixed metal phosphate compound (HMnFePO₄·H₂O), lithium carbonate (Li₂CO₃), titanium (e.g., TiO₂), magnesium (e.g., MgO), niobium (Nb₂O₅), yttrium (Y₂O₃) or cobalt (e.g., Co₃O₄). The dopant elements may be added in dry or wet form and may be further mixed into the precursor slurry to form a second slurry. The dopant element(s) may be mixed using a planetary mixer. In addition, or alternatively, other mixers may be used. The mixer can be capable of exhibiting speeds of up to 10,000 rotations per minute, including all values and ranges from 10 rotations per minute to 10,000 rotations per minute.

Block 106 depicts milling the precursor and the at least one dopant element. Milling provides an improved surface area and improved homogeneity of the cathode active materials including the precursor and the at least one dopant element, which may enhance the electric vehicle battery capacity and cycle life. Various milling techniques may be used, including, for example, ball milling, which involves mixing and grinding the cathode active material in a rotating cylinder with hard balls. Another example of milling may include high-energy milling, which uses higher speeds and energy to achieve fine particles. The method 100 then moves to block 108.

Block 108 depicts adding a carbon precursor to the slurry. The carbon precursor may include, for example, glucose. Other examples of a carbon precursor may include carbon black and/or carbon nanotubes. The carbon precursor may be added in a dry or wet form and may be distributed throughout the slurry. The slurry may be further mixed using a ball mill and/or a high-shear mixer to ensure a homogenous mixture. Mixing the slurry prevents agglomeration and ensures that the carbon precursor is well dispersed. In some instances at this step, the slurry may also be coated onto the cathode 24 and/or the current collector 32 and dried to remove any existing solvent to form a solid cathode active material. In some instances, the cathode active material may be calendered, which includes compressing the cathode active material to improve contact between particles and enhance mechanical properties of the cathode active material. Method 100 then moves to block 112.

Block 110 depicts calcinating the slurry. Calcinating the slurry involves heating the slurry to a high temperature to achieve desired chemical and physical properties of the cathode active material. During calcination, several reactions may occur. First, lithium compounds can react with metal oxides to form a final lithium metal oxide structure. Additionally, the cathode active material may undergo oxidation, which can be crucial for achieving correct valence states of involved metals. Further, the high temperatures of calcination facilitate formation of desired crystalline phases, which are essential for electrochemical performance of the cathode active material.

In an example, calcinating the slurry includes subjecting the cathode active material to high temperatures in a controlled atmosphere. It will be appreciated that the temperature of the calcination step may include using a variety of temperatures. This may occur in a furnace and may involve heating the slurry/cathode active material to a temperature ranging between 500° C. to 900° C. One specific example includes calcinating the cathode active material with a carbon coating at a temperature between about 600-800° C. In this context, one of skill in the art would understand the term “about.” Alternatively, the term “about” is understood to mean plus or minus 5° C. After calcination, the cathode active material may be slowly cooled to ambient temperature, which helps in achieving a desired microstructure and phase stability. The cathode active material may then undergo additional process steps, for example milling if the cathode active material has not yet been coated on the cathode 24.

The lithium manganese iron phosphate (LMFP) based vehicle battery cell 20 and battery pack 12 for the electric vehicle 10 of the present disclosure is advantageous and beneficial over prior art. Multi element-doped LMFP cathode active materials exhibit an improved charge capability including a lower charge voltage and a higher constant current (CC) capacity ratio. The optimized LMFP cathode active materials disclosed herein deliver a higher constant current charge ratio during a charging process. Compared to conventional LMFP cathode materials, the optimized LMFP cathode active materials exhibit improved discharge rate performance, higher discharge voltage, and enhanced 1 C/1 C cycling stability.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A lithium manganese iron phosphate (LMFP) based vehicle battery cell, comprising:
a cathode current collector;
a cathode including a multiple element-doped active material disposed on a surface of the cathode current collector, the active material including:
lithium manganese iron phosphate (LMFP) formed using multiple element doping having the formula LiMnₐFe_{b}Mg_{c}Ti_{d}CoₑNb_{f}Y_{g}PO₄, wherein a+b+c+d+e+f+g=1, and wherein
a is equal to or greater than 0.5;
b is equal to or greater than 0.1;
c is equal to or greater than 0.0005 and equal to or less than 0.1;
d is equal to or greater than 0.0005 and equal to or less than 0.1;
e is equal to or less than 0.05;
f is equal to or less than 0.02; and
g is equal to or less than 0.05.

2. The lithium manganese iron phosphate (LMFP) based vehicle battery cell of claim 1, wherein a is between 0.5 and 0.8.

3. The lithium manganese iron phosphate (LMFP) based vehicle battery cell of claim 1, wherein b is equal to or greater than 0.2 and equal to or less than 0.5.

4. The lithium manganese iron phosphate (LMFP) based vehicle battery cell of claim 1, wherein c is between 0.01 and 0.05.

5. The lithium manganese iron phosphate (LMFP) based vehicle battery cell of claim 1, wherein d is between 0.005 and 0.03.

6. The lithium manganese iron phosphate (LMFP) based vehicle battery cell of claim 1, wherein e is between 0.005 and 0.03.

7. The lithium manganese iron phosphate (LMFP) based vehicle battery cell of claim 1, wherein f is between 0.0001 and 0.01.

8. The lithium manganese iron phosphate (LMFP) based vehicle battery cell of claim 1, wherein g is between 0.0005 and 0.02.

9. The lithium manganese iron phosphate (LMFP) based vehicle battery cell of claim 1, wherein the cathode includes a carbon coating that is between 0.5-10 weight % (wt. %).

10. The lithium manganese iron phosphate (LMFP) based vehicle battery cell of claim 1, wherein a primary particle size of the cathode is between 10-1000 nanometers, and wherein a secondary particle size of the cathode is between 0.5-20 micrometers.

11. The lithium manganese iron phosphate (LMFP) based vehicle battery cell of claim 1, wherein a tap density of the cathode is between 0.3-2.0 grams per cubic centimeter.

12. The lithium manganese iron phosphate (LMFP) based vehicle battery cell of claim 1, wherein a specific surface area of the cathode is between 3-50 square meters per gram.

13. A battery for an electric vehicle, comprising:
a battery cell, the battery cell including:
a cathode including a multiple element doped active material disposed on a surface of a cathode current collector, the active material including:
lithium manganese iron phosphate (LMFP) formed using multiple element doping having the formula LiMnₐFe_{b}Mg_{c}Ti_{d}CoₑNb_{f}Y_{g}PO₄, wherein a+b+c+d+e+f+g=1, and wherein
a is equal to or greater than 0.5;
b is equal to or greater than 0.1;
c is equal to or greater than 0.0005 and equal to or less than 0.1;
d is equal to or greater than 0.0005 and equal to or less than 0.1;
e is equal to or less than 0.05;
f is equal to or less than 0.02; and
g is equal to or less than 0.05.
an anode disposed on an anode current collector;
a separator positioned between the cathode and the anode; and
an electrolyte configured for carrying ions between the cathode and the anode.

14. The battery for the electric vehicle of claim 13, wherein the cathode includes a carbon coating that is between 0.5-10 weight % (wt. %).

15. The battery for the electric vehicle of claim 13, wherein a primary particle size of the cathode is between 10-1000 nanometers, and wherein a secondary particle size of the cathode is between 0.5-20 micrometers.

16. The battery for the electric vehicle of claim 13, wherein a tap density of the cathode is between 0.3-2.0 grams per cubic centimeter.

17. The battery for the electric vehicle of claim 13, wherein a specific surface area of the cathode is between 3-50 square meters per gram.

18. A method for forming a cathode for a battery cell in an electric vehicle battery pack, comprising:
forming a precursor, the precursor including
manganese(II) sulfate (MnSO₄);
iron(II) sulfate (FeSO₄); and
phosphoric acid (H₃PO₄);
adding at least one dopant element to the precursor, wherein the at least one dopant element includes at least one of the following:
a hydrated mixed metal phosphate compound (HMnFePO₄·H₂O);
lithium carbonate (Li₂CO₃);
titanium oxide;
magnesium oxide;
cobalt oxide;
yttrium oxide; or
niobium oxide;
wherein a slurry is formed;
milling the precursor and the at least one dopant element;
adding a carbon precursor to the slurry; and
calcinating the slurry to form an active cathode material.

19. The method for forming a cathode electrode for an electric vehicle battery in claim 18, wherein the carbon precursor is glucose.

20. The method for forming a cathode electrode for an electric vehicle battery in claim 18, wherein calcinating the slurry includes calcinating at a temperature between about 600-800° C.
